(19) United States
(12) Patent Application Publication
(10) Pub. No.: US 2007/0115497 A1
(43) Pub. Date: May 24, 2007

(54) Document Management System

(75) Inventor: Russell Paul Cowburn, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Ingenia Holdings (UK) Limited, London (GB)

(21) Appl. No.: 11/553,930

(22) Filed: Oct. 27, 2006

Related U.S. Application Data
(60) Provisional application No. 60/731,531, filed on Oct. 28, 2005.

(51) Int. Cl. G06K 15/00

(52) U.S. Cl. 358/1.14; 358/1.15

(57) ABSTRACT

A document management method and apparatus implemented in a network environment containing a document management system (DMS), at least one multi-function device (MFD) and a network connecting the document management system to the MFDs. The MFD activities of scan, fax, copy and print are integrated with a DMS using signatures obtained from an intrinsic natural characteristic of hard copies of documents, such as optical speckle from paper, as the hard copies are processed by the MFD. In this way the lifecycle of hard copies within an office can be automatically logged on the DMS, and optionally also the processes can be controlled according to rights over the documents held by different users.

### BACKGROUND OF THE INVENTION

The invention relates to document management, more especially to integration of document management (DM) systems with multi-function devices (MFD).

In a modern office environment, documents are often created electronically using applications software, such as a word processing package or a desktop publisher. However, many documents continue to enter an office in the form of hard copies, such as incoming conventional mail, or faxes (i.e. faxes). These may or may not be routinely converted to electronic form by scanning procedures depending on the office policies and types of documents. For example, incoming faxes may be integrated with the electronic systems, and many times not printed out at all, whereas conventional mail may be treated conventionally, and only scanned onto the computer system in special cases. When documents are originated electronically within the office, it is also still the case that hard copies continue to play a major role in editing, reviewing and distribution. Even in an environment in which paperless office procedures have been fully implemented, it is still common practice for individuals to work on files by printing out hard copies from the electronic files, or relevant portions thereof. These hard copies are then disposed of after the task has been completed.

The backbone of a modern office is a networked computer system including file servers and applications software for document creation and other document handling. Increasingly the documents are handled within a DM system, which is a database layer integrated with different application software packages for creating and viewing documents with which documents can be collated and retrieved.

The modern office is also equipped with so-called MFDs, or more specifically multi-function printers (MFPs). These devices are networked to the main office network and may look like a conventional photocopying machine, or a conventional printer, or a conventional facsimile machine, but in functional terms are networked peripherals that perform one or more of: printing, copying, scanning, faxing, and emailing. In this patent specification we use MFDs as a generic term for such devices, even if they only have a single function, such as print only or fax only.

MFDs thus become the interface between the electronic world governed by the DM system, file servers and so forth, and the paper world of hard copies collated into physical files.

In this environment the concept of a document becomes “dematerialised” in that the document becomes a label for the information and the representation of that information it constitutes. In other words, it may be an “electronic document”, i.e. a computer file, or a “hard copy”, i.e. a conventional document printed on paper. In this patent specification, we use the term document in a dematerialised way, and refer to the document having electronic and physical instances. A print job may thus be thought of as converting an electronic instance of a document to a physical instance of the same document. A scan job converts a physical instance of a document into an electronic instance of the same document. A copy job converts a physical instance of a document into one or more further physical instances of the same document.

Prior to the widespread use of networked computer systems and MFDs for document handling, procedures for handling classified, secret or confidential documents were widespread in the military and government sectors, and were based on the then-valid assumption that there was only one file for any given matter and rapid copying was impossible. However these security measures have become largely ineffective or meaningless with the development of high-speed photocopiers and then MFDs in combination with the spread of electronic creation, storage, processing and distribution of documents. One symptom of this problem is the seeming inevitability of leaks of sensitive information regarding any matter of media interest, such as leaks from government departments, companies, sports clubs and so forth.

To address these concerns, considerable effort has been devoted in recent years to measures for controlling and monitoring document handling, both in the case of electronic and physical instances of documents.

Security of electronic instances of documents within a network environment can now be well managed by ascribing suitable sets of rights to documents and users, as well as by using encryption techniques, digital signatures and a variety of other software-implemented security measures. Other security measures have been developed specifically for MFDs. One security measure is overwriting the image data stored on the hard drive of an MFD. Another security measure is only to release documents from an MFD when the authorised user (typically the person who has sent the print job to the MFD) has identified themselves as being next to the MFD by entering their user i.d. or by some other means.

Security of physical instances of documents within the office environment is more problematic.

One technique for document tracking is for printers to print encoded invisible marks on any printed document identifying the origin of the document, but even though the marks are invisible to the human eye will still be reproduced on copying with a MFD or conventional photocopier. An example is to use yellow dots to encode the date and time the document was printed and the serial number of the printer. However, there is questionable social acceptance of such practices, since they are pervasive and imposed on anyone who uses such a printer, whether it be for home use or office use. This blanket security marking of all printed documents is thus arguably contrary to established principles of the right to privacy and personal freedoms, as evidenced by recent adverse publicity.

Another proposal is to use special paper in which passive radio frequency identification (RFID) sensors are embedded. Each piece of paper can then be tracked within an office. Not only can the physical location of each piece of paper be tracked, but the MFDs can read the RFID sensor on any paper it is handling, and this information can be integrated into the DM system. Thus both the paper that is being copied from, and the blank paper onto which is being printed, can be uniquely identified. While this is a very powerful capability it requires the use of special paper with embedded RFID sensors. Its adoption will therefore probably be limited to high security offices or offices where workflow management is critical. The long-term stability and robustness of the RFID sensors may also be an issue.

Another security issue with physical instances of documents which is becoming increasingly important is document destruction. Uncontrolled document destruction by shredding or other means has in recent years often been associated with major scandals such as Enron and so forth. By contrast to other important document lifecycle activities, tracking and control of destruction of documents has received relatively little attention.

In summary, there is still a need for improved interfacing between electronic and paper instances of documents in an office environment, and for improved tracking and control of paper instances of documents in the office environment throughout their lifecycle.

### SUMMARY OF THE INVENTION

Recently it has been discovered that highly secure and stable digital signatures can be obtained from normal paper and a variety of other common media, and these signatures are near unique identifiers of the specific piece of paper or other medium. The present invention relates to the application of this technology to provide tracking and control of paper instances of documents in a networked office environment containing MFDs.

According to a first aspect of the invention there is provided a document management method implemented in a network environment containing a document management system, at least one multi-function device (MFD) and a network connecting the document management system to the at least one MFD, the method comprising:

(a) a user issuing a command to an MFD to create a new electronic or physical instance of a document from an existing physical instance of the document;

(b) providing the existing physical instance of the document to the MFD;

(c) the MFD determining a signature from the existing physical instance of the document based upon an intrinsic natural characteristic thereof; and

(d) logging the command by associating the signature with an electronic instance of the document stored in a document management system.

The signature may be compared with existing signatures stored in the document management system to establish if the signature is recognised as being associated with an existing document stored in the document management system.

The method may further comprise: creating a new electronic instance of the existing physical instance of the document, and comparing the new electronic instance with electronic instances of documents stored in the document management system to establish if the document is recognised as being associated with an existing document stored in the document management system.

If the signature is recognised, then the command can be logged against the existing document.

The method may further comprise: executing the command conditional on recognising the signature as being from an existing document and establishing that the user has the right to issue the command in respect of the document based on rights stored for the document in the document management system.

If the signature is recognised, then the owner of the document can be established from the document management system and notified regarding the command.

The method may further comprise: storing a new electronic instance of the document created by the MFD in the document management system with the signature.

The method of may further comprise: receiving a user i.d. identifying the user who issued the command and optionally storing the user i.d. as part of the logging.

The method may further comprise: when the user issues a command to create a new physical instance of a document, determining a signature of the new physical instance of the document based upon an intrinsic natural characteristic thereof; and logging the new signature with the electronic instance of the document stored in a document management system.

According to a second aspect of the invention there is provided a document management method implemented in a network environment containing a document management system, at least one multi-function device (MFD) and a network connecting the document management system to the at least one MFD, the method comprising:

(a) a user issuing a command over the network to an MFD to create a new physical instance of a document from an existing electronic instance of the document;

(b) providing the existing electronic instance of the document to the MFD over the network;

(c) the MFD creating the new physical instance of the document;

(d) the MFD determining a signature from the new physical instance of the document based upon an intrinsic natural characteristic thereof; and

(e) logging the command by associating the signature with the electronic instance of the document stored in the document management system.

The method may further comprise: storing a user i.d. identifying the user who issued the command as part of the logging.

The method may further comprise: executing the command conditional on the user having the right to issue the command in respect of the document based on rights stored for the document in the document management system.

The method may further comprise: establishing the owner of the document from the document management system, and notifying the owner of the document regarding the command.

According to a third aspect of the invention there is provided a document management method implemented in a network environment containing a document management system, at least one multi-function device (MFD) and a network connecting the document management system to the at least one MFD, the method comprising:

(a) a user issuing a command to an MFD to dispose of an existing physical instance of a document;

(b) providing the existing physical instance of the document to the MFD;

(c) the MFD determining a signature from the existing physical instance of the document based upon an intrinsic natural characteristic thereof, and

(d) logging the command by associating the signature with an electronic instance of the document stored in a document management system.

The signature may be compared with existing signatures stored in the document management system to establish if the signature is recognised as being associated with an existing document stored in the document management system.

The method may further comprise: creating a new electronic instance of the existing physical instance of the document, and comparing the new electronic instance with electronic instances of documents stored in the document management system to establish if the document is recognised as being associated with an existing document stored in the document management system.

If the signature is recognised, then the command can be logged against the existing document.

The method may further comprise: executing the command conditional on recognising the signature as being from an existing document and establishing that the user has the right to issue the command in respect of the document based on rights stored for the document in the document management system.

If the signature is recognised, then the owner of the document may be established from the document management system and notified of the document regarding the command.

The method may further comprising: storing a new electronic instance of the document created by the MFD in the document management system with the signature.

The method may further comprise: receiving a user i.d. identifying the user who issued the command, and optionally storing the user i.d. as part of the logging.

If the signature is recognised, then the owner of the document may be established from the document management system and notified of the document regarding the command.

The command can be executed by destroying the physical instance of the document within the MFD or passing the physical instance of the document into a waste compartment of the MFD.

Said physical instances may be printed on paper or a variety of other media, including plastics, such as those used as acetates for presentations. The intrinsic natural characteristic may be a characteristic of paper, plastic or other medium, and may be a surface property thereof or a property of the interior of the medium.

The intrinsic natural characteristic is preferably determined by the MFD exposing said physical instance with coherent light. More specifically, the signature may be determined by the MFD: scanning coherent light over the physical instance of the document, and collecting a set of data points from signals obtained as the coherent light is scattered therefrom, wherein different ones of the data points relate to scatter from different parts of the physical instance of the document; and determining the signature from the set of data points.

According to one embodiment, there is provided a document management method implemented in a network environment containing a document management system, at least one multi-function device (MFD) and a network connecting the document management system to the at least one MFD, the method comprising: (a) recording creation of new physical instances of a document from existing electronic instances of the document according to the method of the second aspect of the invention; and (b) recording disposal of existing physical instances of the document according to the method of the third aspect of the invention.

According to one embodiment, there is provided a document management method implemented in a network environment containing a document management system, at least one multi-function device (MFD) and a network connecting the document management system to the at least one MFD, the method comprising: (a) recording creation of new electronic or physical instances of a document from existing physical instances of the document according to the method of the first aspect of the invention; and (b) recording disposal of existing physical instances of the document according to the method of the third aspect of the invention.

According to one embodiment, there is provided a document management method implemented in a network environment containing a document management system, at least one multi-function device (MFD) and a network connecting the document management system to the at least one MFD, the method comprising: (a) recording creation of new physical instances of a document from existing electronic instances of the document according to the method of the second aspect of the invention; (b) recording creation of new electronic or physical instances of the document from existing physical instances of the document according to the method of the first aspect of the invention; and (c) recording disposal of existing physical instances of the document according to the method of claim third aspect of the invention.

It will be understood that office is used in a broad sense to describe any organisation having a networked computer system, and should not be limited to service industry locations and the like, but rather include manufacturing sites, government departments or any other locations.

Further aspects of the invention relate to MFDs, to a DMS, and to a system comprising at least one MFD, a DMS and an interconnecting network.

### BRIEF DESCRIPTION OF THE DRAWINGS

For a better understanding of the invention and to show how the same may be carried into effect reference is now made by way of example to the accompanying drawings in which:

FIG. 1A is a perspective view of a scan head of an embodiment of the invention with a sheet of paper also being shown;

FIG. 1B is a side view of the scan head of FIG. 1A with a sheet of paper;

FIG. 2 is a schematic perspective view showing how the paper surface is sampled n times over its scan area by scanning an elongate beam across it;

FIG. 3 is a block schematic diagram of the functional components of a system for creating authenticatable articles;

FIG. 4A is a perspective view of one embodiment of an MFD having the external form of a printer;

FIG. 4B is a perspective view of another embodiment of an MFD having the external form of a photocopier machine;

FIG. 4C is a perspective view of a further embodiment of an MFD having the external form of a fax machine or digital sender;

FIG. 5 shows schematically in side view an alternative imaging arrangement for a scanner embodying the invention based on directional light collection and blanket illumination;

FIG. 6 shows schematically in plan view the optical footprint of a further alternative imaging arrangement for a scanner embodying the invention in which directional detectors are used in combination with localised illumination with an elongate beam;

FIG. 7 is a microscope image of a paper surface with the image covering an area of approximately 0.5×0.2 mm;

FIG. 8A shows raw data from a single photodetector using the scan head of FIG. 1A which consists of a photodetector signal and an encoder signal;

FIG. 8B shows the photodetector data of FIG. 8A after linearisation with the encoder signal and averaging the amplitude;

FIG. 8C shows the data of FIG. 8B after digitisation according to the average level;

FIG. 9 is a flow diagram showing how a digital signature of an article is generated from a scan;

FIG. 10 is a flow diagram showing a printing process during which the paper being printed on is scanned and its digital signature computed and stored in a database;

FIG. 11 is a flow diagram showing how a digital signature of an article obtained from a scan can be verified against a database in which the digital signatures of previously scanned articles are stored;

FIG. 12 is a flow diagram showing the overall process of how a document is scanned for verification purposes and the results presented to a user;

FIG. 13 is a schematic block diagram of a typical office network with MFDs;

FIG. 14 is a schematic representation of software components of a document management system;

FIG. 15 is a schematic block diagram showing a copy job carried out by an MFD in accordance with the invention and its interaction with the document management system;

FIG. 16 is a schematic block diagram showing a scan job carried out by an MFD in accordance with the invention and its interaction with the document management system;

FIG. 17 is a schematic block diagram showing a receive fax job carried out by an MFD in accordance with the invention and its interaction with the document management system;

FIG. 18 is a schematic block diagram showing a transmit fax job carried out by an MFD in accordance with the invention and its interaction with the document management system;

FIG. 19 is a schematic block diagram showing a digital send job carried out by an MFD in accordance with the invention and its interaction with the document management system;

FIG. 20 is a schematic block diagram showing a print job carried out by an MFD in accordance with the invention and its interaction with the document management system; and

FIG. 21 is a schematic block diagram showing a dispose job carried out by an MFD in accordance with the invention and its interaction with the document management system.

### DETAILED DESCRIPTION

The digital signature scanning technology used in embodiments of the present invention is as described in WO2005/088533 and WO2005/088517, the contents of which are incorporated herein by reference.

The digital signature scanning technology and how it is integrated into several example MFDs is now described.

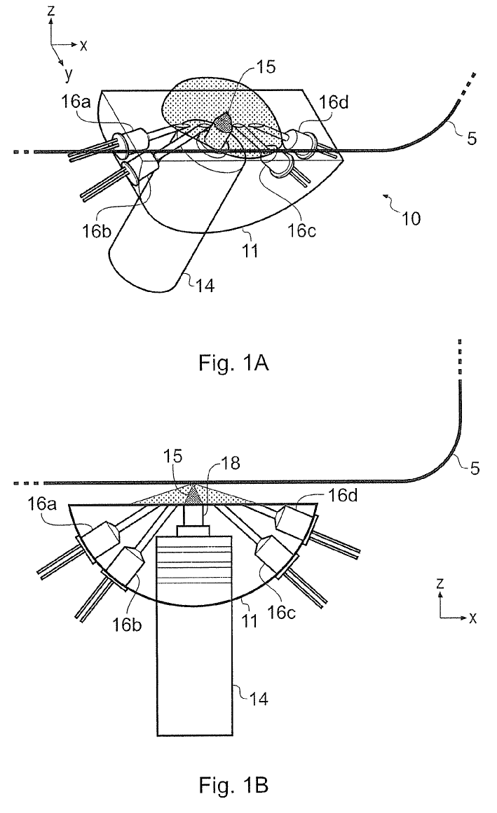

FIGS. 1A and 1B are schematic representations in perspective and side view respectively of a scan head 10 of an embodiment of the invention. The scan head 10 is for measuring a digital signature from a piece of paper 5 or other printable article which is conveyed past the scan head 10 in the x-direction through its reading volume (see inset axes in the drawing). The principal optical components are a laser source 14 for generating a coherent laser beam 15 and a detector arrangement 16 made up of a plurality of k photodetector elements, where k=4 in this example, labelled 16a, 16b, 16c and 16d. The laser beam 15 is focused by a cylindrical lens 18 into an elongate focus extending in the y direction (perpendicular to the plane of the drawing) and lying in the plane of the paper path. In an example prototype, the elongate focus has a major axis dimension of about 2 mm and a minor axis dimension of about 40 micrometres. These optical components are contained in a mounting block 11. In the illustrated embodiment, the four detector elements 16a . . . d are distributed either side of the beam axis offset at different angles in an interdigitated arrangement from the beam axis to collect light scattered in reflection from an article present in the reading volume. In an example prototype, the offset angles are −70, −20, +30 and +50 degrees. Light access to the detector elements 16a . . . d is provided by through holes in the mounting block 11. The angles either side of the beam axis are chosen so as not to be equal so that the data points they collect are as independent as possible. All four detector elements are arranged in a common plane. The photodetector elements 16a . . . d detect light scattered from the surface of paper 5 being conveyed past the scan head 10 when the coherent beam scatters from the paper 5. As illustrated, the source is mounted to direct the laser beam 15 with its beam axis in the z direction, so that it will strike the paper 5 at normal incidence.

Generally it is desirable that the depth of focus is large, so that any differences in the paper positioning in the z direction do not result in significant changes in the size of the beam incident on the paper. In an example prototype, the depth of focus is approximately 0.5 mm which is sufficiently large to produce good results. The parameters, of depth of focus, numerical aperture and working distance are interdependent, resulting in a well known trade off between spot size and depth of focus.

When the scan head 10 is integrated into an otherwise conventional printer, the paper feed mechanism will serve to move the paper linearly in the x direction past the scan head 10 so that the beam 15 is scanned in a direction transverse to the major axis of the elongate focus. Since the coherent beam 15 is dimensioned at its focus to have a cross-section in the xz plane (plane of the drawing) that is much smaller than a projection of the reading volume in a plane normal to the coherent beam, i.e. in the plane of the paper 5, the paper feed will cause the coherent beam 15 to sample many different parts of the paper.

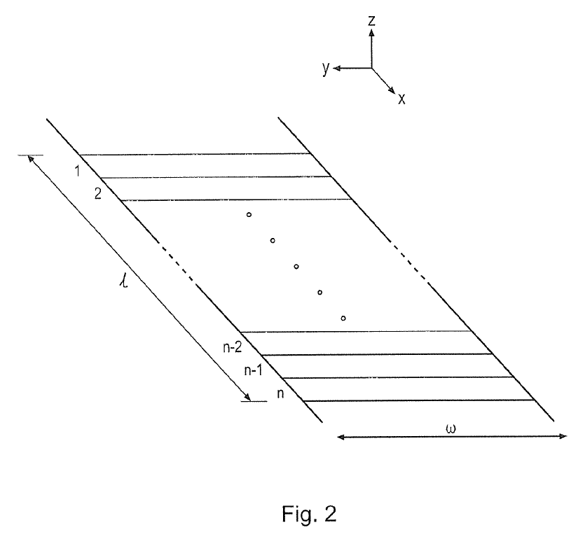

FIG. 2 is included to illustrate this sampling and is a schematic perspective view showing how the reading area is sampled n times by scanning an elongate beam across it. The sampling positions of the focused laser beam as it is scanned over the paper under action of the paper feed is represented by the adjacent rectangles numbered 1 to n which sample an area of length ‘I’ and approximate width ‘w’, where ‘w’ is the long dimension of the cylindrical focus. Data collection is made so as to collect signal at each of the n positions as the paper is conveyed past the scan head. Consequently, a sequence of k×n data points are collected that relate to scatter from the n different illustrated parts of the paper. Typically, only a portion of the paper's length will be sampled. For example, length ‘1’ may be approximately a few centimetres.

With an example minor dimension of the focus of 40 micrometers, and a scan length in the x direction of 2 cm, n=500, giving 2000 data points with k=4. A typical range of values for k×n depending on desired security level, article type, number of detector channels ‘k’ and other factors is expected to be 100<k×n<10,000. It has also been found that increasing the number of detectors k also improves the insensitivity of the measurements to surface degradation of the article through handling, printing etc. In practice, with the prototypes used to date, a rule of thumb is that the total number of independent data points, i.e. k×n, should be 500 or more to give an acceptably high security level with a wide variety of surfaces.

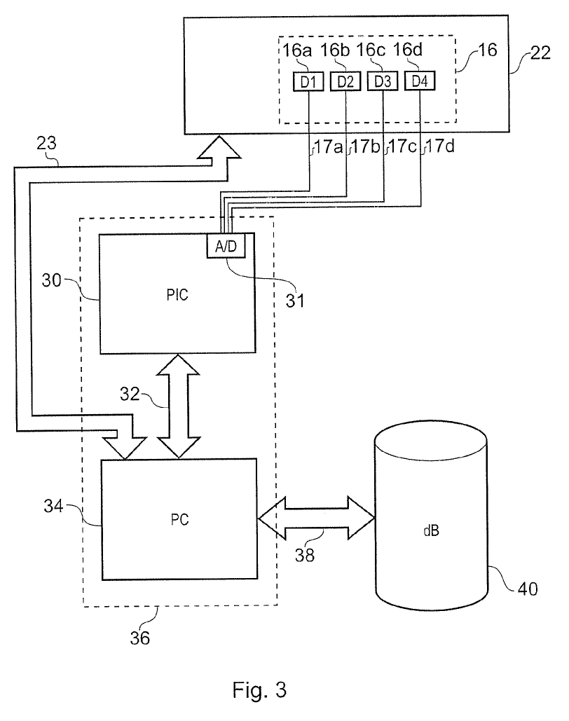

FIG. 3 is a block schematic diagram of the functional components of a system for creating authenticatable articles. A printer 22 is connected to a personal computer (PC) 30 with a conventional connection 25. The detectors 16a . . . d of the detector module 16 are connected through respective electrical connection lines 17a . . . d to an analogue-to-digital converter (ADC) that is part of a programmable interrupt controller (PIC) 30. It will be understood that optical or wireless links may be used instead of, or in combination with, electrical links. The PIC 30 is interfaced with a personal computer (PC) 34 through a serial connection 32. The PC 34 may be a desktop or a laptop. As an alternative to a PC, other intelligent devices may be used, for example a personal digital assistant (PDA) or a dedicated electronics unit. The PIC 30 and PC 34 collectively form a data acquisition and processing module 36 for determining a signature of the article from the set of data points collected by the detectors 16a . . . d. The PC 34 has access through an interface connection 38 to a database (dB) 40. The database 40 may be resident on the PC 34 in memory, or stored on a drive thereof. Alternatively, the database 40 may be remote from the PC 34 and accessed by wireless communication, for example using mobile telephony services or a wireless local area network (LAN) in combination with the internet. Moreover, the database 40 may be stored locally on the PC 34, but periodically downloaded from a remote source.

The database 40 is for compiling a library of digital signatures. The PC 34 is programmed so that in use it obtains scan data from the detectors 16a . . . d each time a document is printed out by the printer 22 and from this data computes a digital signature. A new record is then created in the database 40 containing the digital signature, an image file of what has been printed on the piece of paper and also bibliographic data relevant to the document.

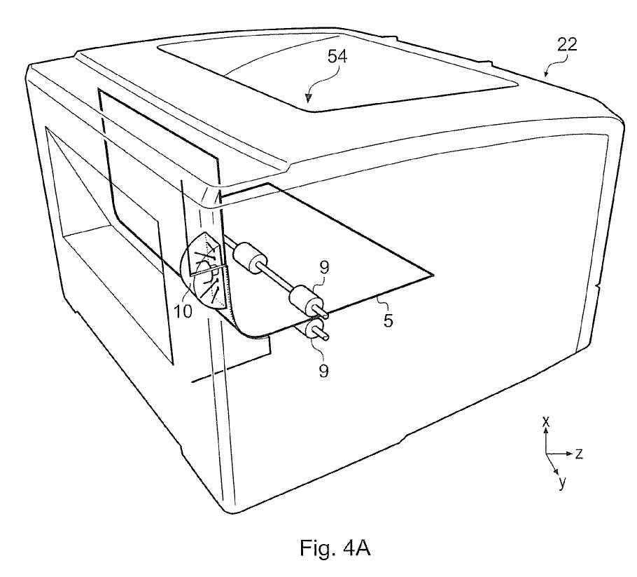

FIG. 4A is a perspective view of an MFD 22 having the form factor of a printer and the above-described scan head 10 integrated into it. The MFD printer 22 is conventional other than by virtue of the scan head and associated electronics. To schematically represent the paper feed mechanism the final roller pair 9 thereof is shown. The roller pair 9 is shown in the process of feeding a sheet of paper 5, after printing, past the scan head 10 prior to its delivery to the output tray 54. It will be appreciated that the paper feed mechanism includes additional rollers and other mechanical parts. In the prototype built already, the scan head is for convenience mounted as illustrated directly after the final roller paper. It will be appreciated that the scan head could be mounted in many different positions along the feed path of the paper. Moreover, although the illustration is of a laser printer, it will be appreciated that any kind of printing device could be used.

FIG. 4B is a perspective view of another embodiment of an MFD 50 having the external form of a photocopier machine with the above-described scan head 10 integrated into it. The MFD photocopier 50 can be conventional other than by virtue of the scan head and associated electronics. The MFD photocopier 50 can have conventional features such as a document scanning unit 51, which may include an input tray 52 for source papers which may include an automatic sheet feeder unit. Also, a paper tray 53 may be provided for holding paper or other media to be copied onto. The MFD photocopier 50 may also have a document output tray 54 to allow a user easy access to copies made using the MFD photocopier 50. The MFD photocopier 50 is also illustrated as having a disposal unit 57 which is a non-standard item now described. The disposal unit 57 is a confidential waste bin integrated into the photocopier housing, the function of which in the context of the invention is described in more detail further below. The disposal unit 57 collects paper or other physical instances of documents for disposal which have been fed into the MFD via the scanning unit 51, typically using the input tray 52 with automatic sheet feeder unit, for the specific purpose of being placed in confidential waste for later secure collection followed by incineration or perhaps long-term archiving. In another example, the disposal unit 57 may incorporate a paper destruction mechanism such as a shredder. MFD photocopier machines are manufactured by a number of companies, including Xerox Incorporated, Ricoh Company Limited and Canon K.K.

In the MFD photocopier 50 of the present example, a scan head 10 is integrated into each of the document scanning unit 51 and the document output tray 54. As illustrated in cutaway portion 55, the document scanning unit 51 of the present example includes a scan head 10 in a paper path 56 of the automatic sheet feeder unit so as to allow scanning of documents being copied. The document output tray 54 also has a scan head 10 integrated thereinto, so as to be able to scan output documents.

It will be appreciated that the scan heads 10 could be mounted in many different positions along the respective feed paths of the copied documents and of the copy documents created by the MFD photocopier.

In another example, documents may be copied using a linked scanner machine and printer machine. In such an example, the scanner machine can be equipped with a scan head to scan documents being scanned, and the printer machine can be equipped with a scan head to scan documents being printed. Thus, what is effectively a two-part photocopier can be used.

It will also be appreciated that the MFD machine 50 may be a multi-function machine capable of performing several of: scanning, printing, faxing, and digital sending of emails, as well as copying, such machines sometimes being referred to as document centres.

FIG. 4C is a perspective view of a further embodiment of an MFD 60 having the external form of a fax machine or digital sender. In the following description, it is referred to as a fax machine. The MFD fax machine 60 has the above-described scan head 10 integrated into it. The MFD fax machine 60 can be conventional other than by virtue of the scan head and associated electronics. The MFD fax machine 60 can have conventional features such as an input tray 52 with document feed unit 61, and an output tray 54 for holding documents which have been transmitted via fax, transmission receipts produced by the MFD fax machine 60 and printed copied of documents received via fax. The MFD fax machine 60 may also have control keys 63 to allow a user to program a transmission destination, and a screen 64 for transmission and operation information to be displayed to a user. MFD fax machines are manufactured by a number of companies, including Xerox Incorporated and Canon K.K.

In the MFD fax machine 60 of the present example, a scan head 10 is integrated into each of the document feed unit 61 and the output tray 54. As illustrated, the document feed unit 61 of the present example includes a scan head 10 so as to allow scanning of documents being transmitted. The output tray 64 also has a scan head 10 integrated thereinto, so as to be able to scan documents received at the MFD fax machine 60.

It will be appreciated that the scan heads 10 could be mounted in many different positions along the respective feed paths of the documents for transmission and of the documents received by the MFD fax machine.

It will be appreciated that a similar form factor MFD machine may be a digital sender, which is a machine that scans in documents like a fax machine, but emails them to their destination as an email attachment. Typically, the email attachment will be an image file, such as a pdf or TIFF format file, but this need not be the case. Some MFDs combine both fax and digital sending functions.

Thus there has now been described several example MFDs which all have integrated signature generation apparatus suitable for interfacing with document management systems.

The above-described examples are based on localised excitation with a coherent light beam of small cross-section in combination with detectors that accept light signal scattered over a much larger area that includes the local area of excitation. It is possible to design a functionally equivalent optical system which is instead based on directional detectors that collect light only from localised areas in combination with excitation of a much larger area.

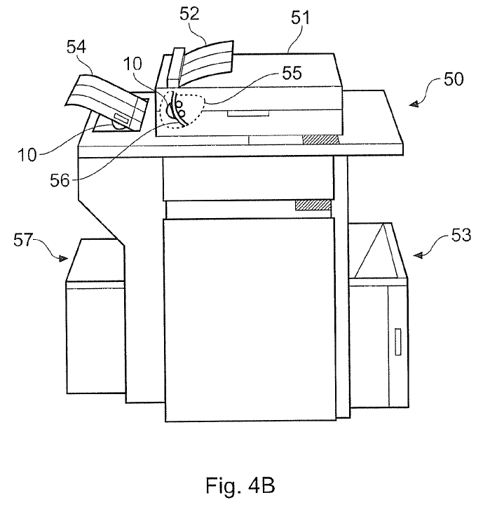

FIG. 5 shows schematically in side view such an imaging arrangement for a reader embodying the invention which is based on directional light collection and blanket illumination with a coherent beam. An array detector 48 is arranged in combination with a cylindrical microlens array 46 so that adjacent strips of the detector array 48 only collect light from corresponding adjacent strips along the paper 5. With reference to FIG. 2, each cylindrical microlens is arranged to collect light signal from one of the n sampling strips. The coherent illumination can then take place with blanket illumination of the whole area being sampled (not shown in the illustration).

A hybrid system with a combination of localised excitation and localised detection may also be useful in some cases.

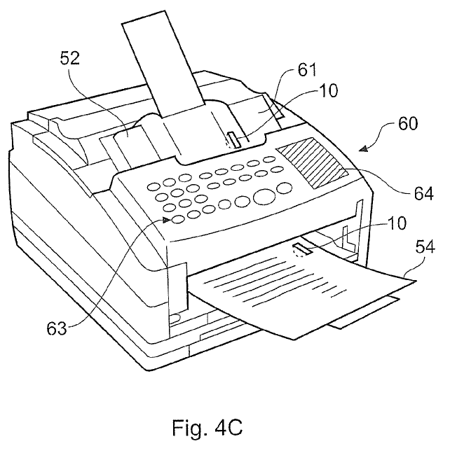

FIG. 6 shows schematically in plan view the optical footprint of such a hybrid imaging arrangement for a scanner embodying the invention in which directional detectors are used in combination with localised illumination with an elongate beam. This embodiment may be considered to be a development of the embodiment of FIGS. 1A & 1B in which directional detectors are provided. In this embodiment three banks of directional detectors are provided, each bank being targeted to collect light from different portions along the ‘1×w’ excitation strip. The collection area from the plane of the reading volume are shown with the dotted circles, so that a first bank of, for example 2, detectors collects light signal from the upper portion of the excitation strip, a second bank of detectors collects light signal from a middle portion of the excitation strip and a third bank of detectors collects light from a lower portion of the excitation strip. Each bank of detectors is shown having a circular collection area of diameter approximately 1/m, where m is the number of subdivisions of the excitation strip, where m=3 in the present example. In this way the number of independent data points can be increased by a factor of m for a given scan length 1. As described further below, one or more of different banks of directional detectors can be used for a purpose other than collecting light signal that samples a speckle pattern. For example, one of the banks may be used to collect light signal in a way optimised for barcode scanning in the case that a barcode is printed, for example to encode some aspect of the document, such as its bibliographic data. If this is the case it will generally be sufficient for that bank to contain only one detector, since there will be no advantage obtaining cross-correlations when only scanning for contrast.

Having now described the principal structural components and functional components of various apparatuses suitable for carrying out the invention, the numerical processing used to determine a digital signature is now described. It will be understood that this numerical processing is implemented for the most part in a computer program that runs on the PC 34 with some elements subordinated to the PIC 30.

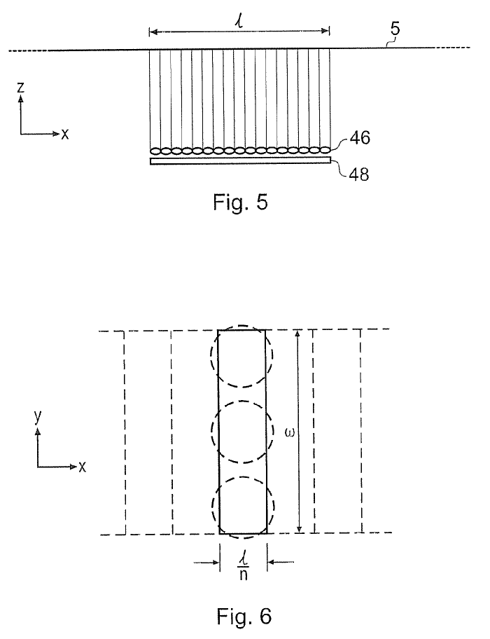

FIG. 7 is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood fibres that make up paper. The figure is also illustrative of the characteristic length scale for the wood fibres which is around 10 microns. This dimension has the correct relationship to the optical wavelength of the coherent beam to cause diffraction and hence speckle, and also diffuse scattering which has a profile that depends upon the fibre orientation. It will thus be appreciated that if a scan head is to be designed for a specific class of printable substrate material, the wavelength of the laser can be tailored to the structure feature size of the class of material to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

In other words, the inventor has discovered that it is essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

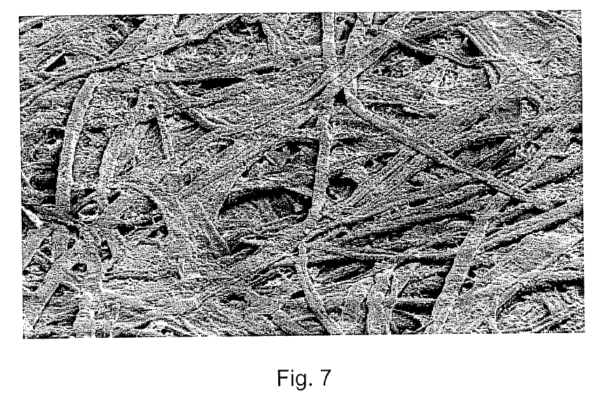

FIG. 8A shows raw data from a single one of the photodetectors 16a . . . d of the scan head of FIG. 1A. The graph plots signal intensity I in arbitrary units (a.u.) against point number n (see FIG. 2). The higher trace fluctuating between I=0-250 is the raw signal data from photodetector 16a. The lower trace is the encoder signal picked up from the markers 28 (see FIG. 2) which is at around I=50.

FIG. 8B shows the photodetector data of FIG. 8A after linearisation with the encoder signal (n.b. although the x axis is on a different scale from FIG. 8A, this is of no significance). In addition, the average of the intensity has been computed and subtracted from the intensity values. The processed data values thus fluctuate above and below zero.

FIG. 8C shows the data of FIG. 8B after digitisation. The digitisation scheme adopted is a simple binary one in which any positive intensity values are set at value 1 and any negative intensity values are set at zero. It will be appreciated that multi-state digitisation could be used instead, or any one of many other possible digitisation approaches. The main important feature of the digitisation is merely that the same digitisation scheme is applied consistently.

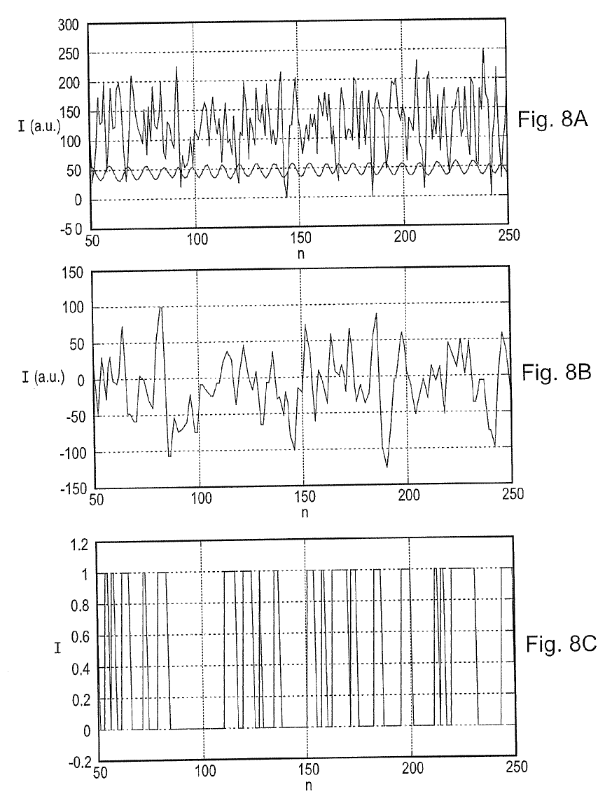

FIG. 9 is a flow diagram showing how a signature of an article is generated from a scan.

Step S1 is a data acquisition step during which the optical intensity at each of the photodetectors is acquired approximately every 1 ms during the entire length of scan. Simultaneously, the encoder signal is acquired as a function of time. It is noted that if the paper feed mechanism has a high degree of linearisation accuracy then linearisation of the data may not be required. The data is acquired by the PIC 30 taking data from the ADC 31. The data points are transferred in real time from the PIC 30 to the PC 34. Alternatively, the data points could be stored in memory in the PIC 30 and then passed to the PC 34 at the end of a scan. The number n of data points per detector channel collected in each scan is defined as N in the following. Further, the value aₖ(i) is defined as the i-th stored intensity value from photodetector k, where i runs from 1 to N. Examples of two raw data sets obtained from such a scan are illustrated in FIG. 8A.

Step S2 uses numerical interpolation to locally expand and contract aₖ(i) so that the encoder transitions are evenly spaced in time. This corrects for local variations in the motor speed. This step is performed in the PC 34 by a computer program.

Step S3 is an optional step. If performed, this step numerically differentiates the data with respect to time. It may also be desirable to apply a weak smoothing function to the data. Differentiation may be useful for highly structured surfaces, as it serves to attenuate uncorrelated contributions from the signal relative to correlated (speckle) contributions.

Step S4 is a step in which, for each photodetector, the mean of the recorded signal is taken over the N data points. For each photodetector, this mean value is subtracted from all of the data points so that the data are distributed about zero intensity. Reference is made to FIG. 8B which shows an example of a scan data set after linearisation and subtraction of a computed average.

Step S5 digitises the analogue photodetector data to compute a digital signature representative of the scan. The digital signature is obtained by applying the rule: aₖ(i)>0 maps onto binary ‘1’ and aₖ(i)<=0 maps onto binary ‘0’. The digitised data set is defined as dₖ(i) where i runs from 1 to N. The signature of the article may advantageously incorporate further components in addition to the digitised signature of the intensity data just described. These further optional signature components are now described.

Step S6 is an optional step in which a smaller ‘thumbnail’ digital signature is created. This is done either by averaging together adjacent groups of m readings, or more preferably by picking every cth data point, where c is the compression factor of the thumbnail. The latter is preferred since averaging may disproportionately amplify noise. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist. The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients are useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and a₁(i), where k≠1 and k,1 vary across all of the photodetector channel numbers. The normalised cross-correlation function Γ is defined as

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of aₖ(i). If the detectors are arranged in pairs either side of normal incidence as in the reader described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background.

The digital signature data obtained from scanning an article can then be written to the database by adding a new record together with an image file of what has been printed onto the substrate and associated bibliographic data. A new database record will include the digital signature obtained in Step S5 as well as optionally its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database. It is noted that the same process can be used when obtaining a digital signature for verification purposes subsequently as is described further below.

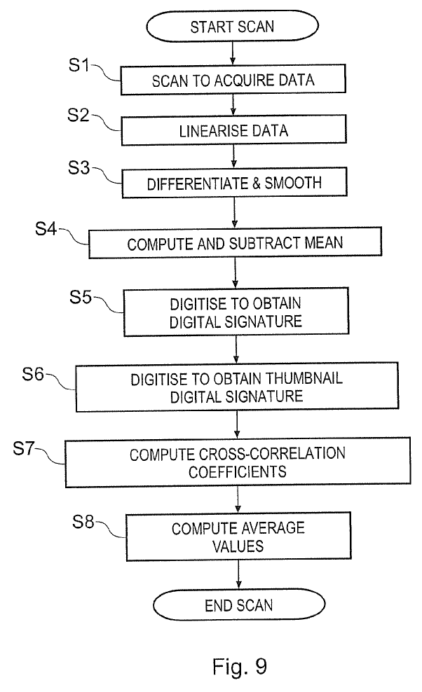

FIG. 10 is a flow diagram showing a printing process during which the paper being printed on is scanned and its digital signature computed and stored in a database. A user of the PC 30 prepares a document for printing using a word processor, drawing package or other type of application software for creating documents. Once the document is ready, a print command is issued. An image file is then created by the application software using an appropriate printer driver. This image file is then sent to the printer for printing. As the paper on which the image is being printed is being fed through the printer, the scan head scans a portion of the paper. The scatter signals thus collected are converted into data points as described above and a digital signature is computed according the process described above with reference to FIG. 9. A database record is then created to store not only the digital signature, but also the image file and relevant bibliographic data relating to the document creation.

It is noted that it is convenient to store the image file created by the printer driver, but that is not the only possibility. The image file could be another file type derived from the printer driver image file, or an image file in a preferred format of the application software used to create the document, or another format created by the application software. Another possibility would be for the image file to be derived from a rescan of the document after printing. For example, this could be done automatically in a printing device in the format of a networked photocopier machine that has sophisticated paper feed (and re-feed) options and an integrated document scanner. In this case, the image representation stored in the database would include any features on the substrate as well as what was printed on the substrate. For example, if the paper is headed paper, the header would be included. This may be advantageous in some circumstances. A wide variety of solutions is possible. All that is important is to store some kind of visual representation of what has been printed.

The above text describes how documents are scanned at source inside a printing device whenever they are generated in order to obtain a digital signature unique to the paper or other substrate on which some representation has been printed, and the digital signature stored in a database together with a representation of what has been printed. The following text describes how documents generated in this way can later be verified as authentic, or alternatively how documents can be tested to establish whether they have been generated by the authorised source.

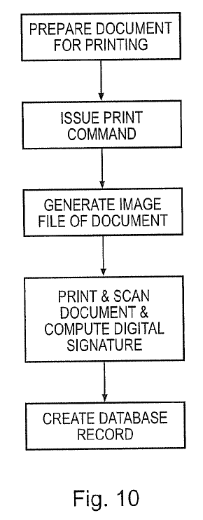

FIG. 11 is a flow diagram showing how a signature of an article obtained from a scan is compared with a signature database, which may be integrated into a document management system, in order to verify whether the article being scanned is recognised as a document on the document management system.

In a simple implementation, the database could simply be searched to find a match based on the full set of signature data. However, to speed up the verification process, the process preferably uses the smaller thumbnails and pre-screening based on the computed average values and cross-correlation coefficients as now described.

The verification process takes place after scanning an article according to the process described above, i.e. to perform Scan Steps S1 to S8 illustrated in FIG. 9.

Verification Step V1 takes each of the thumbnail entries and evaluates the number of matching bits between it and tₖ(i+j), where j is a bit offset which is varied to compensate for errors in placement of the scanned area. The value of j is determined and then the thumbnail entry which gives the maximum number of matching bits. This is the ‘hit’ used for further processing.

Verification Step V2 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to end and issue fail result).

Verification Step V3 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to end and issue fail result).

Verification Step V4 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qk bits per block. A typical value for q is 4 and a typical value for k is 4, making typically 16 bits per block. The qk bits are then matched against the qk corresponding bits in the stored digital signature dₖ^{db}(i+j). If the number of matching bits within the block is greater or equal to some pre-defined threshold Zₜₕᵣₑₛₕ, then the number of matching blocks is incremented. A typical value for Zₜₕᵣₑₛₕ is 13. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of Z_{threshold}), M is the number of matching blocks and p(M) is the probability of M or more blocks matching accidentally. The value of s is determined by comparing blocks within the data base from scans of different objects of similar materials, e.g. a number of scans of paper documents etc. For the case of q=4, k=4 and Z_{threshold}=13, we find a typical value of s is 0.1. If the qk bits were entirely independent, then probability theory would give s=0.01 for Z_{threshold}=13. The fact that we find a higher value empirically is because of correlations between the k detector channels and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10⁻¹⁷⁷.

Verification Step V5 issues a result of the verification process. The probability result obtained in Verification Step V4 may be used in a pass/fail test in which the benchmark is a pre-defined probability threshold.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

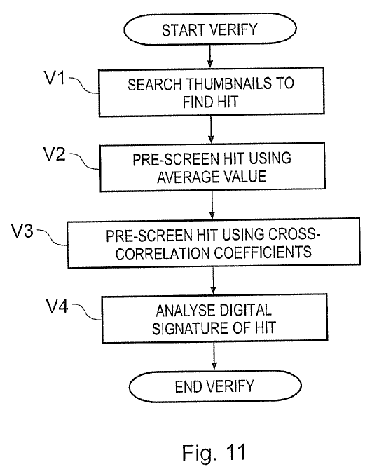

FIG. 12 is a flow diagram showing the overall process of how a physical instance of a document is scanned. First the physical instance of the document is scanned using the scanning system. The document authenticity is then verified using the process of FIG. 11. If there is no matching record in the database, a “no match” result is provided indicating that the document is not recognised as a document already stored in the document management system.

It will be understood that the scan area for obtaining the digital signature is essentially arbitrary in terms of its size or location on the sheet of paper or other physical instance of the document. If desired, the scan could be a linear scan rastered to cover a larger two-dimensional area, for example.

It will be appreciated that there are many forms of MFDs not necessarily thought of in the same way as copiers, printers, fax machines, digital sender and the like, which are nevertheless MFDs for the purpose of the present invention, including point of sale (POS) devices, automated teller machines (ATMs), air ticket boarding card readers, commercial printing presses and many other devices.

Integration of the above-described MFDs with a document management system is now described.

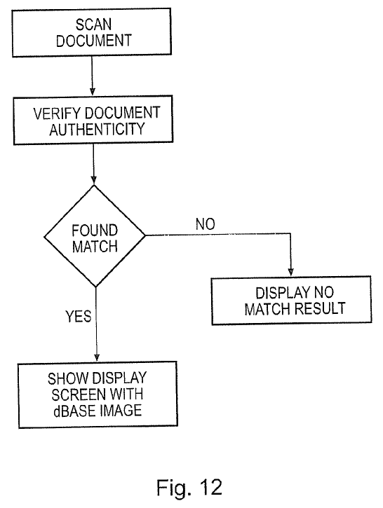

FIG. 13 is a schematic block diagram of a typical office network with MFDs. The office network is depicted as a local area network (LAN) 72 which connects a server 78 with a number of user workstations 80 and also different types of MFD, namely a printer 22 as described above with reference to FIG. 4A, a document centre 50 as described above with reference to FIG. 4B, as well as a digital sender 70 and a fax machine 60 as described above with reference to FIG. 4C. The LAN is also connected to outside the office by an internet communication link 55 to connect to the internet 76 and by one or more telephone lines 65 leading directly from ones of the MFDs to the outside world. The division between internal to the office and external is illustrated schematically by the dashed line 74.

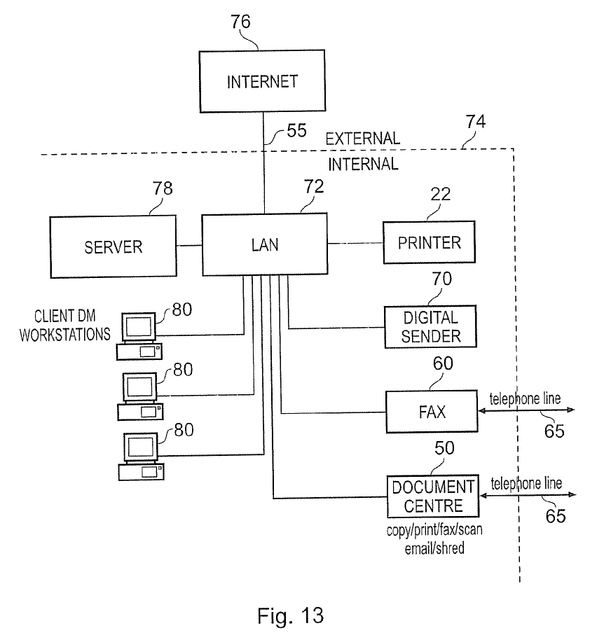

FIG. 14 is a schematic representation of software components of a document management system (DMS) 90 resident on the server 78. The DMS stores documents 92. The DMS also stores digital signatures 94 derived from physical instances of the documents using the signature reading techniques described above. The stored digital signatures are associated with the documents to which they correspond in a database framework, most preferably the same database framework as used for the documents in the DMS. Since each digital signature represents a physical instance of a document, there may be multiple signatures for each document, e.g. one for each physical instance of the document tracked within the system, For the same reason, there may be no digital signature stored for a document, for example if that document has only ever been in electronic form. Further, it will be understood that a digital signature may be obtained for each page of a multi-page document, so the signature storage may be on a page-by-page basis for multi-page documents. For example, it may be that digital signatures are stored for pages 10-12 of a 20 page document, but for no other pages, if only this extract of the whole document has been printed into hard copy. The DMS also stores document rights 96, in that there is a set of rights associated with each document, as is conventionally the case. The rights will be defined in terms of users of the system and the activities they are allowed to exercise over the document, such as read only, read and write, print and so forth. The DMS also stores user identifiers (i.d.s) and user rights 98, as is conventionally the case, for example administrator, manager, operator etc. These are matched up to the document rights 96 to define permissible activities within the DMS.

Having now described the basic environment, we now describe the workflow of specific example activities of copy, scan, fax, digital sending of emails, print and dispose. For the sake of simplicity of wording, we assume that each document is a single page document in the following examples. However, it will be appreciated that this would not be generally true.

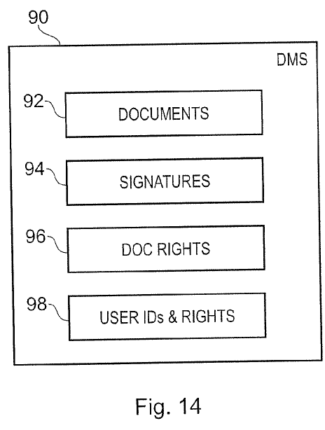

FIG. 15 is a schematic block diagram showing a copy job carried out by an MFD in accordance with the invention and its interaction with the DMS. The MFD may be that shown in FIG. 4B.

The copy job is initiated by placing a source or input document into the input tray 52 of the MFD.

The document feeder then supplies the document to a signature reader 10 which reads the signature and supplies it over the LAN to the DMS 90 via a signal line 104.

The DMS 90 then performs a signature verification process to establish if the signature is recognised as being associated with an existing document stored in the document management system. The match/no match signal is then sent back to the MFD as a control signal 108 to imager 100 and/or printer mechanism 102 parts of the MFD.

The MFD then creates a digital image of the document, i.e. an electronic instance thereof, to be copied using the imager 100 which is a conventional component.

Another method for matching the physical instance of the document to be copied with the DMS is to transmit the digital image of the document by communication line 106 to the DMS and allow the DMS to compare the image, and/or a file extracted from the image, for example using optical character recognition, with electonic instances of documents already stored on the DMS. This may be performed only after failure to match the signature or performed in parallel with the signature comparison.

The digital image may or may not be sent to the DMS 90, and this may be conditional on the match/no match signal. Various control options are possible, including no control.

With no control, the system operates entirely passively to log the copy jobs that are performed. In such case, obviously the control line 108 could be dispensed with. Another control mode is that the copying is performed only if the physical instance of the document supplied for copying is recognised based on a signature match or other kind of match with the DMS.

Another control mode is that copying always proceeds regardless of whether a signature or other match is found, but acts differently depending on whether a match is found. Namely, if a match is found, the signature is associated with the existing electronic instance of the document stored in the DMS, whereas if no match is found, a new electronic instance of the document is stored in the DMS derived from the imager 100 through communication line 106, and the signature supplied through communication line 104. A document that only previously existed outside the DMS is thus added to the DMS automatically as part of the copying process. Further modifications may be envisaged, such as limits on the numbers of copies allowed. This may be useful for enforcing copyright restrictions in a library for example where the source document is a book or journal, and all books or journals released for copying have their digital signatures logged on the DMS.

Assuming that the control mode currently enabled does not kill the copy job, the printer mechanism 102, which is conventional, then proceeds to generate the new physical instance of the document, i.e. the copy.

The paper on which the copy is printed is then scanned by a further signature reader 10 so that the signature of the new paper or other medium is obtained, and this signature is supplied to the DMS through a communication line 110. Finally, the copy is presented to the output tray 54 for collection.

The DMS logging activities that follow from the copy job may thus usefully log the fact that the copy command was issued, optionally including details of the issuer. This will be the case even if the copy job was not permitted owing to lacking of rights. The DMS can also usefully log the signature of the source document and the copy document so that the DMS keeps track of the physical instances of the document that are in circulation, and when and how the new physical instance was created.

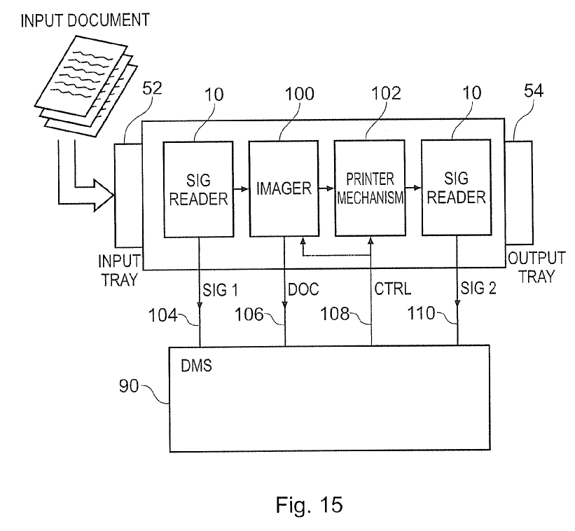

FIG. 16 is a schematic block diagram showing a scan job carried out by an MFD in accordance with the invention and its interaction with the DMS. This may be carried out by a document centre of the form shown in FIG. 4B.

The scan job is initiated by placing a source or input document into the input tray 52 of the MFD.

The document feeder then supplies the document to a signature reader 10 which reads the signature and supplies it over the LAN to the DMS 90 via a signal line 104. The MFD then creates a digital image of the document, i.e. an electronic instance thereof using the imager 100 which is a conventional component and uploads it to the DMS through communication line 106. The signature reading and imaging stages may be reversed.

The DMS 90 thus receives both the scanned digital image of the source document and a signature of the source document.

The digital image is then stored as an image in the DMS and/or is subject to further processing such as optical character recognition (OCR) and conversion into a word processing file or other symbolic format. If the document is recognised by a signature match or other match, as described above in relation to the previous figure, the DMS will associate the new electronic instance of the document with existing electronic instances of the document. In all cases, the digital signature of the physical instance of the document fed into the scanner is associated with the relevant electronic instance(s) of the document stored in DMS.

It will also be appreciated that OCR or other image processing may be carried out on the MFD prior to transmission to the DMS, or after transmission elsewhere in the network.

The scanner may optionally include integral document disposal facility (not shown). This may be a shredder or other on-board destruction device, or a waste bin or a feed to a waste location. This may be the case if the scanner is dedicated to paperless archiving, or a scanner in the post room of a paperless organisation, where all incoming paper mail is immediately destroyed or otherwise disposed of as soon as it is scanned into the electronic systems.

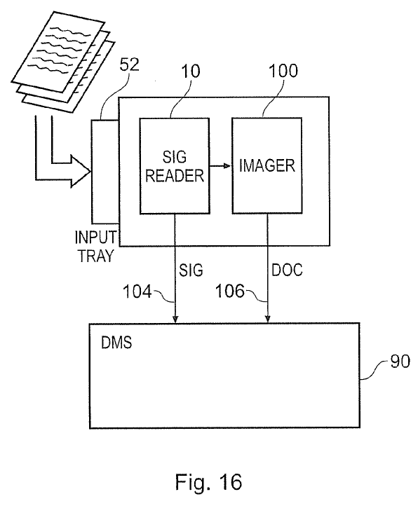

FIG. 17 is a schematic block diagram showing a receive fax job carried out by an MFD in accordance with the invention and its interaction with the DMS. The MFD may be the MFD fax machine shown in FIG. 4C for example.

The fax machine has a transceiver unit 112 with a receiver RX and transmitter TX. An incoming electronic instance of a document is transmitted to the fax machine by a telephone line 65. The decoded signal is then fed to an imager 100 which creates an electronic instance of the document in the form of an image file, which is transmitted to the DMS 90 through a communication line 106. The output from the imager 100 is also supplied to a printer mechanism 102 so that the fax is printed out to an output tray 54 for collection. The hard copy is supplied to the output tray 54 via a signature reader 10 which sends the signature to the DMS 90 through a communication line 104.

The incoming fax is then stored to the DMS 90 which logs the existence of the new physical instance of the document together with its digital signature and other details regarding the incoming transmission such as time, source telephone number etc.

The DMS may also act responsively based on the electronic instance of the document supplied by the imager 100. This instance can be compared with electronic instances of documents already stored in the document management system to establish if the document is recognised as being associated with an existing document stored in the document management system. If it is, then the electronic instance of the incoming fax can be associated with the existing electronic instance(s) of the document, for example as a new version of an existing document. Optionally, relevant details of the existing document to allow it to be easily located by a user may be sent to the printer mechanism and printed onto the incoming fax to facilitate internal distribution and subsequent handling of the paper copy within the office.

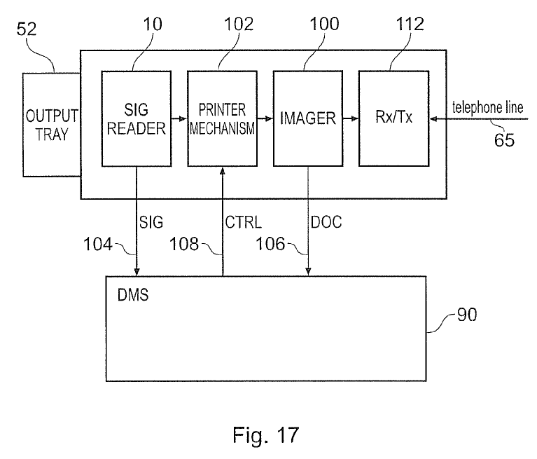

FIG. 18 is a schematic block diagram showing a transmit fax job carried out by an MFD in accordance with the invention and its interaction with the DMS.

The fax machine is the same as described in relation to receiving faxes, but the printer mechanism is not shown in the present figure, since it is not important for the transmit fax job in the context of the invention.

The transmit fax job is initiated by placing a source or input document into the input tray 52 of the MFD.

The document feeder then supplies the document to a signature reader 10 which reads the signature and supplies it over the LAN to the DMS 90 via a signal line 104.

The DMS 90 performs a signature verification process to establish if the signature is recognised as being associated with an existing document stored in the document management system. The match/no match signal is then sent back to the MFD as a control signal 108 to imager 100 and/or transceiver 112.

In one control mode, the transmit fax command may be deleted if there is no match. Moreover, even if there is a match, the command may be deleted if the user attempting to send the fax does not have appropriate rights over the document. The user may be identified by entering a user i.d. into the MFD using a keypad, by biometric verification or other conventional means.

The MFD creates a digital image of the document, i.e. an electronic instance thereof, using the imager 100 and this is supplied on to the transmitter TX for outside communication out of the office by telephone line 65.

In another control mode, fax transmission is always permitted, but an electronic instance of the transmitted document is always stored in the DMS. As previously described, a new electronic instance of the document may be stored derived from the output of the imager, or, if the signature is recognised, merely information regarding the fax transmission may be logged and associated with an existing electronic instance of the document.

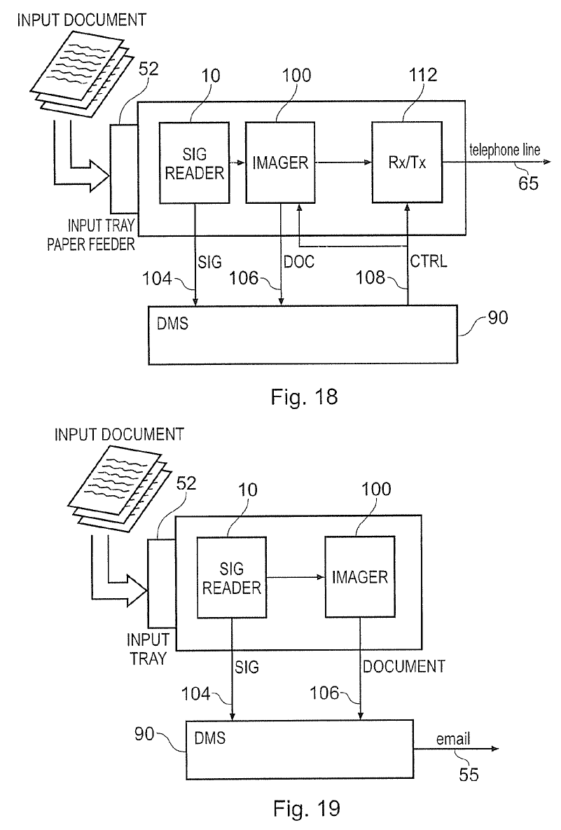

FIG. 19 is a schematic block diagram showing a digital send job carried out by an MFD in accordance with the invention and its interaction with the DMS. This may be carried out using an MFD as shown in FIG. 4C.

The digital send job is initiated by placing a source or input document into the input tray 52 of the MFD.

The document feeder then supplies the document to a signature reader 10 which reads the signature and supplies it over the LAN to the DMS 90 via a signal line 104. The MFD creates a digital image of the document, i.e. an electronic instance thereof, using the imager 100 and this is supplied over the LAN to the DMS 90 via a signal line 106. The order of the signal reading and imaging may be reversed. The DMS 90 then transmits an electronic instance of the document as an email attachment to the recipient over the internet 55. It will be understood that the transmission may in some cases be an internal email sent within the office.

The DMS 90 performs a signature verification process to establish if the signature is recognised as being associated with an existing document stored in the document management system.

In one control mode, the transmit email command may be deleted if there is no match. Moreover, even if there is a match, the command may be deleted if the user attempting to send the email does not have appropriate rights over the document. The user may be identified by entering a user i.d. into the MFD using a keypad, by biometric verification or other conventional means.

In another control mode, email transmission is always permitted, but an electronic instance of the transmitted document is always stored in the DMS. As previously described, a new electronic instance of the document may be stored derived from the output of the imager, or, if the signature is recognised, merely information regarding the email transmission may be logged and associated with an existing electronic instance of the document.

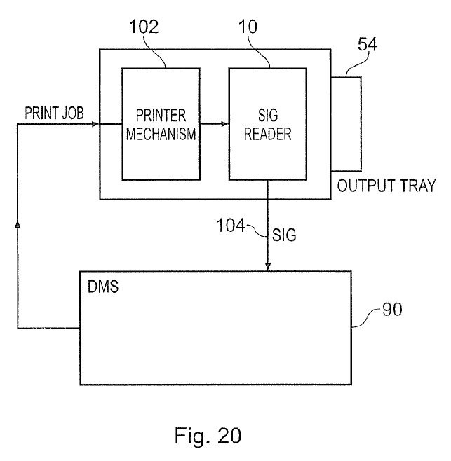

FIG. 20 is a schematic block diagram showing a print job carried out by an MFD in accordance with the invention and its interaction with the DMS. In contrast to the previous examples, the source document of the print job is an electronic instance of a document issued from the DMS 90. The invention operates entirely passively in this example merely to store the digital signature of the new physical instance of the document created by the print job.

Accordingly, the MFD printer's printer mechanism 102 is supplied with a suitable form of the document to be printed, and the signature is scanned in by a reader 10 integral with the printer before the print job arrives at the output tray 54. The signature is sent to the DMS 90 through a communication line 104 as in the previous examples.

It will be appreciated that if multiple copies of the document are printed, then each of these will be logged in the DMS with the signature or signatures.

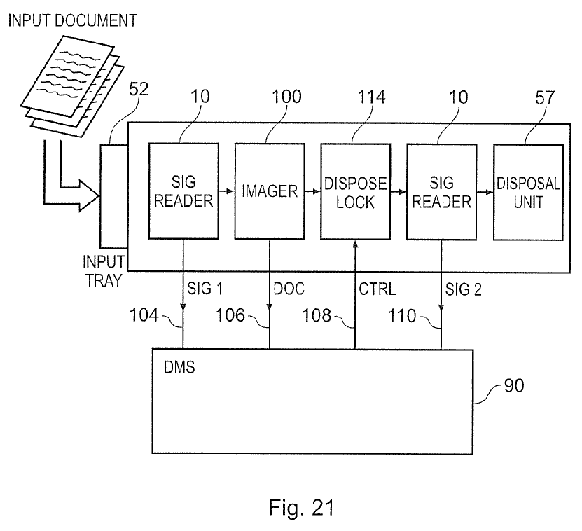

FIG. 21 is a schematic block diagram showing a dispose job carried out by an MFD in accordance with the invention and its interaction with the DMS.

The dispose job is initiated by placing a source or input document into the input tray 52 of the MFD.

The document feeder then supplies the document to a signature reader 10 which reads the signature and supplies it over the LAN to the DMS 90 via a signal line 104.

The MFD then creates a digital image of the document, i.e. an electronic instance thereof, using the imager 100 which is supplied to the DMS 90 through communication line 106.

The source document for disposal is then held in a dispose lock 114 awaiting a disposal decision to be received as a control signal 108 from the DMS 90.

On receipt of confirmation to dispose of the document (see further below), it is then supplied to a disposal unit 57 via a further signature reader 10 which re-scans the signature of the document and transmits it to the DMS 90 through communication line 110 to confirm that the document has been conveyed to the disposal unit 57. The disposal unit 57 may be a storage unit, i.e. a confidential waste bin, integral with or separate from the MFD. Alternatively it may be a shredder or other destructive device.

A variety of modes of operation are possible.

In a passive control mode, all documents proceed to disposal, in which case the MFD does not use its dispose lock 114 or further signature reader 10 which could thus be dispensed with if the MFD was only specified to carry out this mode. However, a signature and an electronic instance of the disposed physical instance of the document are stored in the DMS 90.

In an active control mode, disposal is aborted if the document to be disposed is not recognised as an existing document on the DMS, i.e. if there is no match in the verification process. Moreover, even if there is a match, the command may be deleted if the user attempting to dispose of the document does not have appropriate rights over the document. The user may be identified by entering a user i.d. into the MFD using a keypad, by biometric verification or other conventional means. If disposal is aborted. The source document is ejected from the MFD, e.g. by being sent to an output tray thereof (not shown).

In this way, destruction of documents can be logged.

In summary, by providing MFDs within the office that log both creation of physical instances of documents, e.g. by printing and copying, and their destruction, the number of hard copies in circulation, and the history of all hard copies that exist or have existed can be tracked. This hard copy tracking integrated with the DMS is a powerful tool that can be used for many purposes. For example, it can be used for monitoring compliance with confidentiality or joint venture agreements which may have clauses that require destruction of all copies on termination of the agreement. Moreover, leaks based on misuse of hard copies can be prevented or at least traced by controlling or at least monitoring document transmission outside the office by fax transmissions and digital sending where the source document is a hard copy.

In passive mode, the invention may be used as part of a billing system to pay copyright royalties. For example, in a library it can be important to pay appropriate royalties to publishers for any copies made in the library. With the present invention, copies of copies can be automatically tracked, not just the original copy from the book or journal. Moreover, considerable saving in time and effort may be achieved by the automatic logging afforded by the invention.

Furthermore, document activities that use hard copies can be notified to appropriate persons. For example, the rights in many DM systems include the notion of a document owner. The MFDs or the DMS may be configured so that the document owner is automatically notified of actions performed on hard copies of one of his documents, as identified by signature match or other match. The owner of a document may thus be automatically notified if one of his documents is transmitted externally by email of a digital sender or by a fax transmission, or copied, including information about which user performed the act and other relevant details. Similarly automatically denied requests to perform such activities owing to lack of rights may also be notified to the document owner in the same way, or indeed to security personnel responsible for enforcing internal security.

### REFERENCES

1. WO2005/088533

2. WO2005/088517

3. U.S. Pat. No. 5,978,477

4. U.S. Pat. No. 6,175,714

5. U.S. 2005/0216437

6. U.S. 2005/0182757

7. U.S. 2005/0105724

8. U.S. 2004/0078749

9. U.S. 2004/0074961

10. U.S. 2004/0041707

11. U.S. 2004/0079796

12. U.S. 2004/0041696

13. U.S. Pat. No. 6,860,657

14. U.S. Pat. No. 6,088,119

15. U.S. 2002/0076252

16. U.S. 2004/0179220

17. U.S. Pat. No. 5,642,199

The contents of the above references are incorporated herein in the entirety.

What is claimed is:

1. A document management method implemented in a network environment containing a document management system, at least one multi-function device (MFD) and a network connecting the document management system to the at least one MFD, the method comprising:
(a) a user issuing a command to an MFD to create a new electronic or physical instance of a document from an existing physical instance of the document;
(b) providing the existing physical instance of the document to the MFD;
(c) the MFD determining a signature from the existing physical instance of the document based upon an intrinsic natural characteristic thereof; and
(d) logging the command by associating the signature with an electronic instance of the document stored in a document management system.

2. The method of claim 1, wherein the signature is compared with existing signatures stored in the document management system to establish if the signature is recognised as being associated with an existing document stored in the document management system.

3. The method of claim 1, further comprising: creating a new electronic instance of the existing physical instance of the document, and comparing the new electronic instance with electronic instances of documents stored in the document management system to establish if the document is recognised as being associated with an existing document stored in the document management system.

4. The method of claim 2, wherein, if the signature is recognised, then logging the command against the existing document.

5. The method of claim 2, further comprising: executing the command conditional on recognising the signature as being from an existing document and establishing that the user has the right to issue the command in respect of the document based on rights stored for the document in the document management system.

6. The method of claim 2, wherein, if the signature is recognised, then establishing the owner of the document from the document management system and notifying the owner of the document regarding the command.

7. The method of claim 1, further comprising: storing a new electronic instance of the document created by the MFD in the document management system with the signature.

8. The method of claim 1, further comprising: receiving a user i.d. identifying the user who issued the command.

9. The method of claim 8, storing the user i.d. as part of the logging.

10. The method of claim 1, wherein the user issues a command to create a new physical instance of a document, further comprising:
determining a signature of the new physical instance of the document based upon an intrinsic natural characteristic thereof; and
logging the new signature with the electronic instance of the document stored in a document management system.

11. The method of claim 1, wherein said physical instances are printed on paper.

12. The method of claim 1, wherein the intrinsic natural characteristic is a characteristic of paper.

13. The method of claim 1, wherein the intrinsic natural characteristic is determined by the MFD exposing said physical instance with coherent light.

14. The method of claim 13, wherein the signature is determined by the MFD:
scanning coherent light over the physical instance of the document, and collecting a set of data points from signals obtained as the coherent light is scattered therefrom, wherein different ones of the data points relate to scatter from different parts of the physical instance of the document; and
determining the signature from the set of data points.

15. A document management method implemented in a network environment containing a document management system, at least one multi-function device (MFD) and a network connecting the document management system to the at least one MFD, the method comprising:
(a) a user issuing a command over the network to an MFD to create a new physical instance of a document from an existing electronic instance of the document;
(b) providing the existing electronic instance of the document to the MFD over the network;
(c) the MFD creating the new physical instance of the document;
(d) the MFD determining a signature from the new physical instance of the document based upon an intrinsic natural characteristic thereof; and
(e) logging the command by associating the signature with the electronic instance of the document stored in the document management system.

16. The method of claim 15, further comprising: storing a user i.d. identifying the user who issued the command as part of the logging.

17. The method of claim 15, further comprising: executing the command conditional on the user having the right to issue the command in respect of the document based on rights stored for the document in the document management system.

18. The method of claim 15, further comprising: establishing the owner of the document from the document management system, and notifying the owner of the document regarding the command.

19. The method of claim 15, wherein said physical instances are printed on paper.

20. The method of any preceding claim 15, wherein the intrinsic natural characteristic is a characteristic of paper.

21. The method of any preceding claim 15, wherein the intrinsic natural characteristic is determined by the MFD exposing said physical instance with coherent light.

22. The method of claim 21, wherein the signature is determined by the MFD:
scanning coherent light over the physical instance of the document, and collecting a set of data points from signals obtained as the coherent light is scattered therefrom, wherein different ones of the data points relate to scatter from different parts of the physical instance of the document; and
determining the signature from the set of data points.

23. A document management method implemented in a network environment containing a document management system, at least one multi-function device (MFD) and a network connecting the document management system to the at least one MFD, the method comprising:
(a) a user issuing a command to an MFD to dispose of an existing physical instance of a document;
(b) providing the existing physical instance of the document to the MFD;
(c) the MFD determining a signature from the existing physical instance of the document based upon an intrinsic natural characteristic thereof; and
(d) logging the command by associating the signature with an electronic instance of the document stored in a document management system.

24. The method of claim 23, wherein the signature is compared with existing signatures stored in the document management system to establish if the signature is recognised as being associated with an existing document stored in the document management system.

25. The method of claim 23, further comprising: creating a new electronic instance of the existing physical instance of the document, and comparing the new electronic instance with electronic instances of documents stored in the document management system to establish if the document is recognised as being associated with an existing document stored in the document management system.

26. The method of claim 24, wherein, if the signature is recognised, then logging the command against the existing document.

27. The method of claim 24, further comprising: executing the command conditional on recognising the signature as being from an existing document and establishing that the user has the right to issue the command in respect of the document based on rights stored for the document in the document management system.

28. The method of claim 24, wherein, if the signature is recognised, then establishing the owner of the document from the document management system and notifying the owner of the document regarding the command.

29. The method of claim 23, further comprising: storing a new electronic instance of the document created by the MFD in the document management system with the signature.

30. The method of claim 23, further comprising: receiving a user i.d. identifying the user who issued the command.

31. The method of claim 30, storing the user i.d. as part of the logging.

32. The method of claim 23, wherein, if the signature is recognised, then establishing the owner of the document from the document management system and notifying the owner of the document regarding the command.

33. The method of claim 23, wherein the command is executed by destroying the physical instance of the document within the MFD.

34. The method of claim 23, wherein the command is executed by passing the physical instance of the document into a waste compartment of the MFD.

35. The method of claim 23, wherein said physical instances are printed on paper.

36. The method of claim 23, wherein the intrinsic natural characteristic is a characteristic of paper.

37. The method of claim 23, wherein the intrinsic natural characteristic is determined by the MFD exposing said physical instance with coherent light.

38. The method of claim 37, wherein the signature is determined by the MFD:
scanning coherent light over the physical instance of the document, and collecting a set of data points from signals obtained as the coherent light is scattered therefrom, wherein different ones of the data points relate to scatter from different parts of the physical instance of the document; and
determining the signature from the set of data points.

39. A document management method implemented in a network environment containing a document management system, at least one multi-function device (MFD) and a network connecting the document management system to the at least one MFD, the method comprising:
(a) recording creation of new physical instances of a document from existing electronic instances of the document according to the method of claim 15; and
(b) recording disposal of existing physical instances of the document according to the method of claim 23.

40. A document management method implemented in a network environment containing a document management system, at least one multi-function device (MFD) and a network connecting the document management system to the at least one MFD, the method comprising:
(a) recording creation of new electronic or physical instances of a document from existing physical instances of the document according to the method of claim 1; and
(b) recording disposal of existing physical instances of the document according to the method of claim 23.

41. A document management method implemented in a network environment containing a document management system, at least one multi-function device (MFD) and a network connecting the document management system to the at least one MFD, the method comprising:
(a) recording creation of new physical instances of a document from existing electronic instances of the document according to the method of claim 15;
(b) recording creation of new electronic or physical instances of the document from existing physical instances of the document according to the method of claim 1; and
(c) recording disposal of existing physical instances of the document according to the method of claim 23.
